(19) United States
(12) Patent Application Publication
(10) Pub. No.: US 2014/0282540 A1
(43) Pub. Date: Sep. 18, 2014

(54) PERFORMANT HOST SELECTION FOR VIRTUALIZATION CENTERS

(71) Applicants: Arnaud Bonnet, San Francisco, CA (US); Slater Stich, Sunnyvale, CA (US)

(72) Inventors: Arnaud Bonnet, San Francisco, CA (US); Slater Stich, Sunnyvale, CA (US)

(21) Appl. No.: 14/206,314

(22) Filed: Mar. 12, 2014

Related U.S. Application Data
(60) Provisional application No. 61/780,625, filed on Mar. 13, 2013.

(51) Int. Cl. G06F 9/455

(52) U.S. Cl. CPC G06F 9/45533
USPC 718/1

(57) ABSTRACT

A host for a virtual machine is selected by first electronically receiving (i) a virtual-machine allocation request for resources in a cluster of servers upon which a plurality of virtual machines are executing and (ii) performance data related to the execution of the plurality of virtual machines. The effect of executing a new virtual machine associated with the request on each server using on the gathered performance data is simulated, and a server is selected based on a result of the simulation; the new virtual machine is caused to execute on the selected server.

### CROSS-REFERENCE TO RELATED APPLICATIONS

This application claims priority to and the benefit of U.S. Provisional Patent Application Ser. No. 61/780,625, filed on Mar. 13, 2013, which is hereby incorporated herein by reference in its entirety.

### TECHNICAL FIELD

Embodiments of the present invention relate generally to virtual machines and, in particular, to virtual-machine host selection.

### BACKGROUND

A single computer or computing system (e.g., a server) may run a plurality of virtual machines; frequently, larger numbers of virtual machines are allocated to a group of servers. Each server in the group may have different capabilities (e.g., varying levels of processing power, memory, or storage) making them capable of handling greater or lesser numbers of virtual-machine instances, and the various virtual machines may have different resource requirements (i.e., each virtual-machine instance may put greater or lesser demands on the processing power, memory, or storage of its host server).

In such a shared-hosting managed resource, every virtual machine deployment request may require a host selection wherein it is determined which server will host the requested virtual machine. The manner in which the host server is selected to accommodate the virtual-machine deployment requests may dramatically affect the performance of the hosted virtual machine. For example, a virtualization center may have two physical hosts, A and B, and virtual machines may be placed onto host A until it is “full” (i.e., its disk or network storage is completely used and/or it runs out of active memory), after which virtual machines are placed on host B. This allocation scheme is may be very inefficient, because host B sits completely idle during the time that virtual machines are being instantiated onto host A.

A further complication to the problem is that of “overbooking,” which refers to the practice of assigning more virtual machines to a host than it can be guaranteed to serve at a given time. For example, two virtual machines, which both have requested 8 Gb of active memory, may be assigned to a host that only has 12 Gb of active memory available to hosted virtual machines (i.e., an over-allocation of 4 Gb). In some cases, this over-allocation may pose no performance problems to the virtual machines, because it may be unlikely that both virtual machines will request over 6 Gb of memory at the same time. In practice, however, most virtualization centers practice over-allocation because it is inefficient not to do so—a machine that requests 8 Gb memory, for example, may only use 512 Mb on average, leaving 7.5 Gb idle.

Because the distribution of virtual machines across the physical hosts of a virtualization center dramatically affects the performance of the virtual machines, a need therefore exists for a host selection method and system that decides upon hosts for virtual machines in an efficient (in terms of utilization of cluster resources) and performant (in terms of the virtual machine performance) manner.

### SUMMARY

In general, various aspects of the systems and methods described herein relate to receiving a request for a new virtual machine, collecting data about the request and already running virtual machines on a plurality of hosts, and simulating the effects on the hosts if each one were to accept the request for the new machine. In one embodiment, a failure probability of each host is computed, wherein a host is deemed likely to fail if instantiating the new machine thereon results in an over-allocation of resources. The host with the lowest probability of failure is selected, and a request is sent to instantiate the new virtual machine thereon.

In one aspect, a method for selecting a host for a virtual machine includes electronically receiving a virtual-machine allocation request for resources in a cluster of servers upon which a plurality of virtual machines are executing; electronically receiving performance data related to the execution of the plurality of virtual machines; storing the performance data in a database; computationally simulating the effect of executing a new virtual machine associated with the request on each server using on the gathered performance data; selecting a server based on a result of the simulation; and causing the new virtual machine to execute on the selected server.

The virtual-machine allocation request may include a minimum or maximum computing power, memory size, or input/output bandwidth for the new virtual machine. Gathering performance data may include sending a request for and receiving logging information from the servers and/or receiving historical performance data from a database. Selecting the server may include a least-likely future failure analysis. The virtual-machine allocation request may be received from a client device. The performance data may be received continuously, periodically, or upon receipt of the request. Simulating the effect of executing a new virtual machine may include simulating the memory, CPU, or storage requirements of the new virtual machine and of the plurality of virtual machines for each server. The performance data maybe received from a polling resource.

In another aspect, a system for selecting a host for a virtual machine includes a database for storing performance data related to the execution of the plurality of virtual machines; a computer processor configured for executing computer instructions for computationally executing the steps of: receiving a virtual-machine allocation request for resources in a cluster of servers upon which a plurality of virtual machines are executing; receiving the performance data; simulating the effect of executing a new virtual machine associated with the request on each server using on the gathered performance data; selecting a server based on a result of the simulation; and causing the new virtual machine to execute on the selected server.

The virtual-machine allocation request may include a minimum or maximum computing power, memory size, or input/output bandwidth for the new virtual machine. Gathering performance data may include sending a request for and receiving logging information from the servers and/or receiving historical performance data from a database. Selecting the server may include a least-likely future failure analysis. The virtual-machine allocation request may be received from a client device. The performance data may be received continuously, periodically, or upon receipt of the request. Simulating the effect of executing a new virtual machine may include simulating the memory, CPU, or storage requirements of the new virtual machine and of the plurality of virtual machines for each server. The performance data may be received from a polling resource.

These and other objects, along with advantages and features of the present invention herein disclosed, will become more apparent through reference to the following description, the accompanying drawings, and the claims. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. In the following description, various embodiments of the present invention are described with reference to the following drawings, in which:

FIG. 1 illustrates a computing environment including a host selector and polling resource in accordance with embodiments of the present invention; and

FIG. 2 illustrates a host selector and polling resource in accordance with embodiments of the present invention.

### DETAILED DESCRIPTION

In various embodiments of the present invention, a request for a new virtual machine is received, and host server on which to instantiate the virtual machine is selected by (a) collecting utilization information from each host server and/or from each virtual machine running on each host server, (b) simulating the effects of running the new virtual machine on each host server given the current and/or anticipated future load of the host server, and (c) selecting the host server least likely to fail due to an over-allocation of resources if the new virtual machine is instantiated thereon.

In one embodiment, the host selection is based upon its “least likely future failure.” At the time of the virtual-machine allocation request, some or all of the cluster hosts are polled to see their current and/or future resource utilization; similarly, some or all of the virtual machines on each host are polled for similar information. This information is then used to create a model for what-if analysis for the new virtual machine (i.e., the one to be allocated). For each host in the cluster, the model is used to predict/simulate what would happen if the new virtual machine were placed on that host. In particular, the projected performance of all virtual machines on that host (including the new one) is used to compute the likely length of failure due to over-allocation. The host that minimizes this probability is then selected.

FIG. 1 illustrates an example computing environment 100 in accordance with embodiments of the present invention. A host selector 102 receives a virtual-machine allocation request from a client 106. The request may be analyzed, as explained in greater detail below, to determine the resource requirement associated therewith. A polling resource 106 receives information regarding the loads and/or available resources on a plurality of servers 110, including processing loads, memory loads, and amount of storage space available in storage devices 112. The polling resource 106 may also retrieve historical load information from a performance data store 108. The host selector 102 receives the information collected by the polling resource 106 and, based on it and information collected from the request from the client 104, selects one or more hosts 110 on which to instantiate the one or more virtual machines requested by the client 104. One of skill in the art will understand, however, that the particular implementation illustrated in FIG. 1 is not limiting and merely an illustrative example. Other configurations and architectures are within the scope of the present invention.

As mentioned above, the host selector 102 receives a virtual-machine allocation request from the client 104. The client 104 may be any computing device, such as a workstation, laptop computer, desktop computer, another server, mobile device or smartphone, or any other such device. The request may be received over a wide-area network such as the Internet, a local-area network, or by a direct connection between the client 104 and the host selector 102. The request may be in the form of an email, an SMS text message, or other form of sent electronic communication; in other embodiments, the client 104 makes the request using a web browser or a software application running thereon.

One or more items of data may be extracted from the request. For example, the virtual-machine allocation request may include requested disk storage, requested CPU resources, and/or requested active memory. In other embodiments, other data may be collected instead of or in addition to the aforementioned data; e.g., if the requested virtual machine is a clone of, copy of, or otherwise similar to another virtual machine for which long-term historical data is available (in, e.g., the performance data store 108), various metrics based on that long-term data may be included in addition or substitution to the aforementioned information. These metrics may include, for example, startup resources required, average resources required, minimum and maximum resources required, and/or resources required as a function of time.

In one embodiment, when the virtual-machine allocation request is received, the host selector 102 gathers information about the hosts 110 in the cluster and the virtual machines that are already placed upon these hosts 110 via the polling resource 106. In other embodiments, the collection of the information about the hosts 110 and/or virtual machines thereon is collected continuously or periodically, not only when a new request is received. The type and amount of information gathered may depend upon the performance logging capabilities of the hosts 110 in the cluster. For example, the hosts 110 may report disk storage capacity, CPU load, and available memory thereon, as well as how those resources are currently allocated to one or more virtual machines running thereon. The polling resource 106 may communicate with the hosts 110 via a network such as the Internet or other network, and may use an API, web-based interface, or other such interface. Some hosts 110 may report such utilization data via operating-system level commands, such as the TOP command available in UNIX systems, or by using reporting/logging software applications running thereon.

The polling resource 106 may save any or all data it collects from the hosts 110 in the performance data store 108. The information may be indexed by host, by virtual machine, or by both. Historical data may be saved and associated with other data collected for a given host 110 and/or virtual machine. This historical data may be used by the host selector 102 to enhance the data received in the allocation request if the virtual machine requested is the same as or similar to a virtual machine for which historical data is available in the performance data store 108. Virtual-machine request information may be additionally stored on the performance data store 108; this information may be used instead of or in addition to information collected from the hosts 110 as a further indication of the loads on the hosts 110, particularly if little or no information can be collected from the hosts 110. In other words, the host selector 102 may infer the loads on the hosts 110 based on previous requests sent to the hosts 110.

Once performance data is available for the requested virtual machine, for the cluster hosts 110, and for the virtual machines already deployed on those hosts, the host selector 102 uses this information to simulate or predict the performance of some or all virtual machines on a host 100, including the new one. In other words, the performance of each host 110 is predicted if the new virtual machine were deployed on that host 110.

The nature of the simulation may depend upon the nature of the performance data gathered by the host selector 102. For example, in a cluster having no historical information, the host selector 102 might simply assume an average distribution for all variable resources (CPU utilization, memory usage, etc.) for each virtual machine based upon their resource requests. In a more mature cluster having more detailed historical information, the host selector 102 may use a time-parameterized family of distributions (to account for the fact many most applications experience periodic demand) for each virtual machine, etc. In one embodiment, the host selector 102 creates a software-based model of each host 110 that includes the information collected about the host 110, such as maximum and available memory, CPU, and storage, and allocates the modeled host resources to the existing and requested virtual machines. If any given resource is over-allocated after allocating the virtual-machine requirements thereto, the host selector 102 may predict that the host 110 will fail (that is, become over-allocated) if the requested virtual machine is assigned to it. The host selector 102 may compute a probability and duration of any failures of the host 110 to deliver the resources requested to its virtual machines and select a host 110 having the lowest probability of failure. The simulation may further include an estimate of future resource requirements of the virtual machines, based on available time-domain information related to the resource requirements, and the failure probability may reflect this future requirement. Any such model or simulation is within the scope of the present invention, however.

As one example, a host 110 having 12 Gb of memory is hosting two virtual machines, each of which has requested 8 Gb memory. In this example, the host selector 102 has uses a Poisson model having mean 2 Gb (for any given one-minute interval, say) for each of these virtual machines and has further assumed that the demands posed by the two machines are independent and time-homogeneous. The host selector 102 may then predict that at a given minute, the probability that that the total memory demands from both virtual machines is greater than 12 Gb is about 2%. Thus, for roughly 98% of their deployment time, the host selector 102 predicts that the two virtual machines get all the memory resources that they need.

FIG. 2 illustrates an embodiment of a server 200 that includes the host selector 102 and the polling resource 106 depicted in FIG. 1. In this embodiment, the server 200 includes a processor 202, such as an INTEL XEON, non-volatile storage 204, such as a magnetic, solid-state, or flash disk, a network interface 206, such as ETHERNET or WI-FI, and a volatile memory 208, such as SDRAM. The storage 204 may store computer instructions which may be read into memory 208 and executed by the processor 202. The network interface 206 may be used to communicate with hosts in a cluster and/or a client, as described above. The present invention is not, however, limited to only the architecture of the server 200, and one of skill in the art will understand that embodiments of the present invention may be used with other configurations of servers or other computing devices.

The memory 208 may include instructions 210 for low-level operation of the server 200, such as operating-system instructions, device-driver-interface instructions, or any other type of such instructions. Any such operating system (such as WINDOWS, LINUX, or OSX) and/or other instructions are within the scope of the present invention, which is not limited to any particular type of operating system. The memory further includes instructions for a host selector 212 and a polling resource 214, as described in greater detail above. The host-selector instructions 212 may include instructions 216 for simulating hosts and/or virtual machines and instructions 218 for conducting a failure analysis of hosts when a new virtual machine is added thereto. The polling-resource instructions 214 may include instructions 220 for querying hosts and/or instructions 22 for querying historical information (stored in, for example, the performance data store 108 of FIG. 1). Again, the present invention is not limited to only this allocation of instructions, and any such arrangement is within its scope.

It should also be noted that embodiments of the present invention may be provided as one or more computer-readable programs embodied on or in one or more articles of manufacture. The article of manufacture may be any suitable hardware apparatus, such as, for example, a floppy disk, a hard disk, a CD ROM, a CD-RW, a CD-R, a DVD ROM, a DVD-RW, a DVD-R, a flash memory card, a PROM, a RAM, a ROM, or a magnetic tape. In general, the computer-readable programs may be implemented in any programming language. Some examples of languages that may be used include C, C++, or JAVA. The software programs may be further translated into machine language or virtual machine instructions and stored in a program file in that form. The program file may then be stored on or in one or more of the articles of manufacture.

Certain embodiments of the present invention were described above. It is, however, expressly noted that the present invention is not limited to those embodiments, but rather the intention is that additions and modifications to what was expressly described herein are also included within the scope of the invention. Moreover, it is to be understood that the features of the various embodiments described herein were not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

What is claimed is:

1. A method for selecting a host for a virtual machine, the method comprising:
electronically receiving a virtual-machine allocation request for resources in a cluster of servers upon which a plurality of virtual machines are executing;
electronically receiving performance data related to the execution of the plurality of virtual machines;
storing the performance data in a database;
computationally simulating the effect of executing a new virtual machine associated with the request on each server using on the gathered performance data;
selecting a server based on a result of the simulation; and
causing the new virtual machine to execute on the selected server.

2. The method of claim 1, wherein the virtual-machine allocation request comprises a minimum or maximum computing power, memory size, or input/output bandwidth for the new virtual machine.

3. The method of claim 1, wherein gathering performance data comprises sending a request for and receiving logging information from the servers.

4. The method of claim 1, wherein gathering performance data comprises receiving historical performance data from a database.

5. The method of claim 1, wherein selecting the server comprises a least-likely future failure analysis.

6. The method of claim 1, wherein the virtual-machine allocation request is received from a client device.

7. The method of claim 1, wherein the performance data is received continuously, periodically, or upon receipt of the request.

8. The method of claim 1, wherein simulating the effect of executing a new virtual machine comprises simulating the memory, CPU, or storage requirements of the new virtual machine and of the plurality of virtual machines for each server.

9. The method of claim 1, wherein the performance data is received from a polling resource.

10. A system for selecting a host for a virtual machine, the system comprising:
a database for storing performance data related to the execution of the plurality of virtual machines;
a computer processor configured for executing computer instructions for computationally executing the steps of:
i. receiving a virtual-machine allocation request for resources in a cluster of servers upon which a plurality of virtual machines are executing;
ii. receiving the performance data;
iii. simulating the effect of executing a new virtual machine associated with the request on each server using on the gathered performance data;
iv. selecting a server based on a result of the simulation; and
v. causing the new virtual machine to execute on the selected server.

11. The system of claim 10, wherein the virtual-machine allocation request comprises a minimum or maximum computing power, memory size, or input/output bandwidth for the new virtual machine.

12. The system of claim 10, wherein gathering performance data comprises sending a request for and receiving logging information from the servers.

13. The system of claim 10, wherein gathering performance data comprises receiving historical performance data from a database.

14. The system of claim 10, wherein selecting the server comprises a least-likely future failure analysis.

15. The system of claim 10, wherein the virtual-machine allocation request is received from a client device.

16. The system of claim 10, wherein the performance data is received continuously, periodically, or upon receipt of the request.

17. The system of claim 10, wherein simulating the effect of executing a new virtual machine comprises simulating the memory, CPU, or storage requirements of the new virtual machine and of the plurality of virtual machines for each server.

18. The system of claim 10, wherein the performance data is received from a polling resource.
